(19) United States
(12) Patent Application Publication
(10) Pub. No.: US 2019/0041583 A1
(43) Pub. Date: Feb. 7, 2019

(54) Optical Structure And Apparatus Using The Same

(71) Applicants: Sintai Optical (Shenzhen) Co., Ltd., ShenZhen City (CN); Asia Optical Co., Inc., Taichung (TW)

(72) Inventor: Sung-Po Cheng, Taichung (TW)

(21) Appl. No.: 16/053,941

(22) Filed: Aug. 3, 2018

(30) Foreign Application Priority Data
Aug. 7, 2017 (CN) 201710665783.9

(51) Int. Cl. G02B 6/32; G02B 27/09; G02B 6/02; F41G 1/473

(52) U.S. Cl. CPC G02B 6/32; F41G 1/473; G02B 6/02395; G02B 27/0955

(57) ABSTRACT

An optical structure includes a main body including a first pattern, a glass body including a second pattern, an optical fiber, a first light source, and a second light source. The optical fiber is located between the main body and the glass body and includes a first end. A first color beam is projected from the first light source to be fed into the optical fiber, and is outputted from the first end. A second color beam is projected beam from the second light source to be fed into the glass body, and is outputted from the second pattern. A baseline vertically passes through an aiming pattern constituted by the first pattern and the second pattern. When the aiming pattern is observed in a direction parallel to the baseline, the first end is located at a center of the aiming pattern.

### BACKGROUND OF THE INVENTION

### Field of the Invention

The invention relates to an optical structure, and more particularly to an optical structure with an aiming pattern capable of emitting light, and an apparatus using such an optical structure.

### Description of the Related Art

For a typical sight apparatus with a light-emitting hairline (e.g. a reticle), the hairline emits only one color light at the same time point, resulting in the difficulty in recognition the position of the auxiliary information (e.g. the amount of trajectory compensation) on the hairline and the position of the central point (i.e. an aiming point).

### BRIEF SUMMARY OF THE INVENTION

In view of the above problem, the present disclosure provides an optical structure, in which the disposition of an optical fiber and a glass body enables an aiming pattern in the optical structure to have the ability of displaying two colors. Accordingly, the readability of different information on the aiming pattern may be enhanced.

According to an embodiment, the present disclosure provides an optical structure configured to provide an aiming pattern. The optical structure includes a main body, a glass body, an optical fiber, a first light source, and a second light source. The main body includes a first pattern. The glass body includes a second pattern. The optical fiber is located between the main body and the glass body. The optical fiber includes a first end. The first light source is configured to project a first color beam, and the first color beam is fed into the optical fiber and is outputted from the first end of the optical fiber. The second light source is configured to project a second color beam, and the second color beam is fed into the glass body and is outputted from the second pattern. The first pattern and the second pattern together form the aiming pattern. There is a baseline perpendicularly passes through the aiming pattern. When the aiming pattern is observed in a direction parallel to the baseline, the first end is located at a center of the aiming pattern.

In another embodiment, the second pattern surrounds the first end and the first pattern surrounds the second pattern when the aiming pattern is observed in the direction parallel to the baseline.

In yet another embodiment, the optical fiber further includes a second end. The first color beam is fed into the optical fiber from the second end and propagates toward the first end so that the first color beam is outputted from the first end.

In yet another embodiment, the glass body further includes a surface, and the second pattern is disposed on the surface.

In yet another embodiment, the surface includes a groove and a reflection layer. The reflection layer is disposed in the groove to form the second pattern on the surface.

In yet another embodiment, the groove is formed by etching the surface.

In yet another embodiment, the second color beam is fed into the glass body from a side surface of the glass body and is reflected by the reflection layer so that the second color beam is outputted from the second pattern.

In yet another embodiment, the optical structure further includes a base member configured to allow the main body to be disposed thereto.

In yet another embodiment, the optical structure further includes a mounting bracket configured to be disposed to the base member and also configured to allow the glass body to be disposed thereto. Therefore, the optical fiber can be positioned between the main body and the glass body.

In yet another embodiment, the optical fiber is disposed on the first pattern.

In yet another embodiment, the first light source or the second light source is a bi-color laser diode.

In yet another embodiment, the aiming pattern is crosshair (or reticle).

According to an embodiment, the present disclosure provides another optical structure including a main body, a glass body, an optical fiber, a first light source, and a second light source. The glass body includes a first region. The optical fiber is located between the main body and the glass body and includes a first end. The first light source is configured to project a first color beam, and the first color beam is fed to the optical fiber and is outputted from the first end of the optical fiber. The second light source is configured to project a second color beam, and the second color beam is fed into the glass body and is outputted from the first region. When the first region is observed in a direction parallel to a baseline perpendicularly passing through the first region, it is visible that the first color beam outputted from the first end is present in the second color beam outputted from the first region.

In another embodiment, the first region forms an aiming pattern. In this case, when the aiming pattern is observed in the direction parallel to the baseline, the first end is located in a center of the aiming pattern and the first region surrounds the first end.

In yet another embodiment, the glass body further includes a surface, and the first region is located on the surface.

In yet another embodiment, the surface includes a groove and a reflection layer. The reflection layer is formed in the groove to form the first region on the surface.

In yet another embodiment, the second color beam is fed into the glass body from a side surface of the glass body and then is reflected by the reflection layer. Therefore, the second color beam is outputted from the first region.

In yet another embodiment, the optical fiber further includes another first end. After the first color beam is fed into the optical fiber, the first color beam is outputted from at least one of the first ends. Therefore, it is visible that the first color beam outputted from the at least one of the first ends is present in the second color beam outputted from the first region when the first region is observed in the direction parallel to the baseline.

In yet another embodiment, the main body includes a second region, and the optical fiber is disposed on the second region. The first region and the second region together form an aiming pattern. When the aiming pattern is observed in the direction parallel to the baseline, the first end is located in the center of the aiming pattern, the first region surrounds the first end, and the second region surrounds the first region.

According to one or more embodiments, the present disclosure provides an optical apparatus including the optical structure.

According to one or more embodiments, the present disclosure provides an apparatus having an aiming function, and the apparatus includes the optical structure.

### BRIEF DESCRIPTION OF THE DRAWINGS

The invention can be more fully understood by reading the subsequent detailed description and examples with references made to the accompanying drawings, wherein:

FIG. 1 is an exploded view of an optical structure in one of embodiments of the present disclosure;

FIG. 2 is an enlarged view of the first pattern included in the main body in FIG. 1;

FIG. 3 is a schematic view of the optical fiber in FIG. 1;

FIG. 4 is a lateral view of the glass body in FIG. 1;

FIG. 5 is a schematic view of an aiming pattern provided by the optical structure in FIG. 1; and

FIG. 6 is a schematic view of an optical fiber in another embodiment of the present disclosure.

### DETAILED DESCRIPTION OF THE INVENTION

The present disclosure introduces an optical structure capable of displaying at least two colors serving as signs. This optical structure can be applied to telescopic apparatuses, sights or other apparatuses that are required to provide signs. To clarify the optical structure provided in the present disclosure, the following exemplary description is based on a sight including such an optical structure.

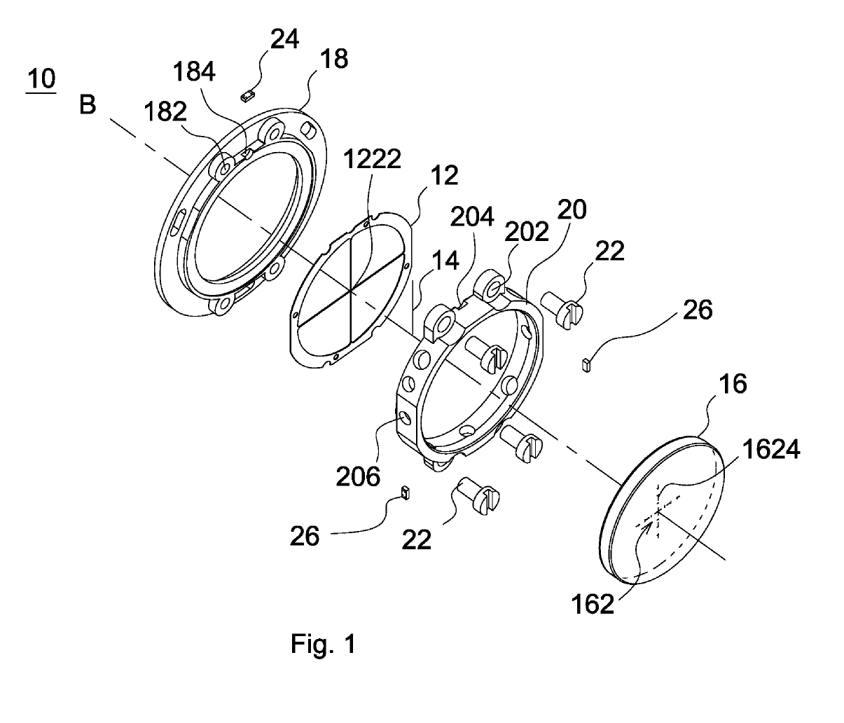

Referring to FIG. 1, an optical structure 10 in an embodiment of the present disclosure includes a main body 12, an optical fiber 14, a glass body 16, a base member 18, a mounting bracket 20, a first light source 24, and two second light sources 26. The optical structure 10 can display at least two colors as signs at the same time. When a user intends to observe a certain target object through the optical structure 10, these signs can be seen in a field of view (FOV) of the optical structure 10.

The optical structure 10 in an example can be used for aiming so that the signs displayed in different colors by the optical structure 10 can constitute an aiming pattern. For example, the optical structure 10 can be applied to a shooting sight apparatus, a rangefinder or a (astronomical) telescope for aiming a certain target object. In this case, the optical structure 10 is disposed in a body together with an eyepiece and an object lens, and the optical structure 10 is disposed between the eyepiece and the object lens to form an optical path. When the optical structure 10 is applied to a sight apparatus, the body further includes an erection lens tube and the optical structure 10 is disposed in the erection lens tube. When the optical structure 10 is applied to a rangefinder, the body further includes a laser emitter and a laser receiver. The laser emitter can emit a laser beam, and the optical path of the laser beam partially overlaps the optical path constituted by the eyepiece, the optical structure 10 and the object lens. Furthermore, the optical structure 10 can also be applied to a sight apparatus for bows. In the case of a bow sight apparatus not having any amplification function, any eyepiece and any object lens may not be disposed respectively in front and back of the optical structure 10. In the case of a bow sight apparatus having an amplification function, an eyepiece and an object lens are respectively disposed in front and back of the optical structure 10 to form an optical path in a body. In short, the optical structure 10 can be applied to any optical device requiring an aiming function. The assembly of these elements is described in detail as follows.

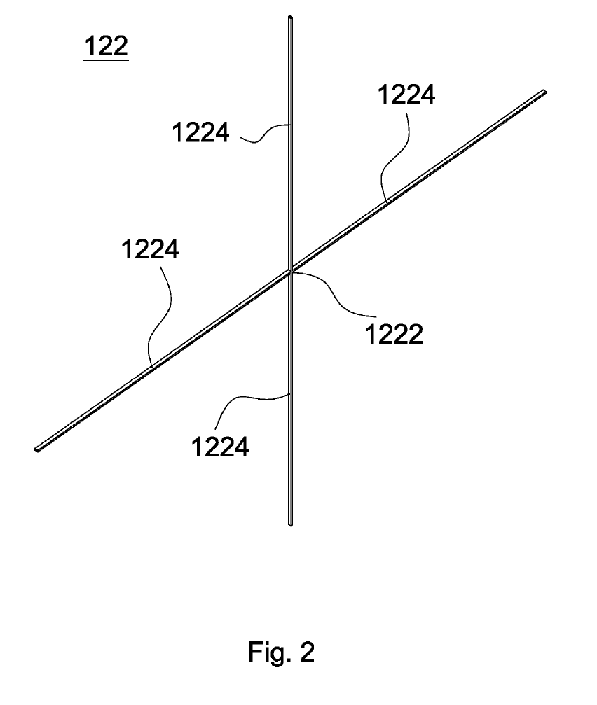

The main body 12 is configured to be disposed to the base member 18, and the main body 12 includes a region in which one or more signs having one or more colors are provided. For example, this region is constituted by at least a first pattern 122. As shown in FIG. 2, the first pattern 122 in this embodiment includes a first central point 1222 and four first branches 1224. These first branches 1224 extend outwardly from the first central point 1222, so as to form a reticle shape.

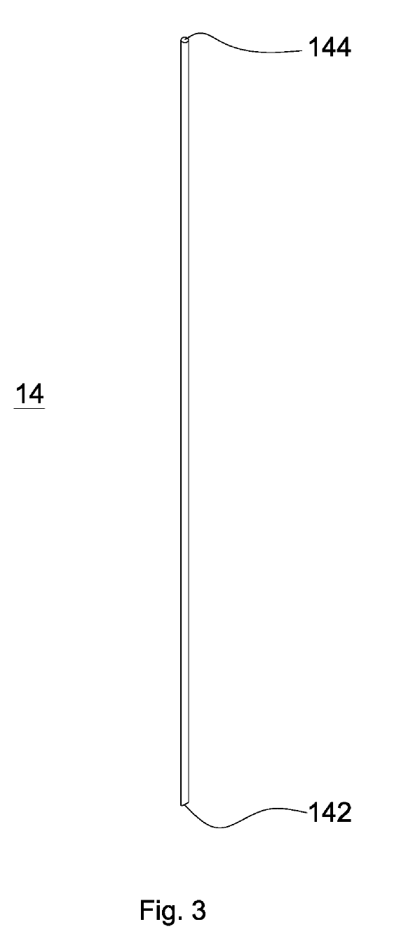

Please refer to FIG. 3. The optical fiber 14 includes a first end 142 and a second end 144. In an embodiment, the optical fiber 14 is disposed on the first pattern 122. The optical fiber 14 and one of the first branches 1224 of the first pattern 122 can be overlapped and assembled together. After the assembling of the optical fiber 14 on the first pattern 122, the first end 142 is located at the first central point 1222, and the second end 144 is located at one end of the first branch 1224 far from the first central point 1222.

There are four through holes 202 formed on the mounting bracket 20 and four fastening holes 182 formed on the base member 18 and respectively corresponding to the four through holes 202. Therefore, the mounting bracket 20 can be disposed to (or secured to) the base member 18 when four fastening members 22 respectively pass though the four through holes 202 and are fastened to the four fastening holes 182. Moreover, the glass body 16 can be disposed to the mounting bracket 20 so that the optical fiber 14 is located between the main body 12 and the glass body 16. In this case, the glass body 16 has a gap of about 0.07 mm with the optical fiber 14.

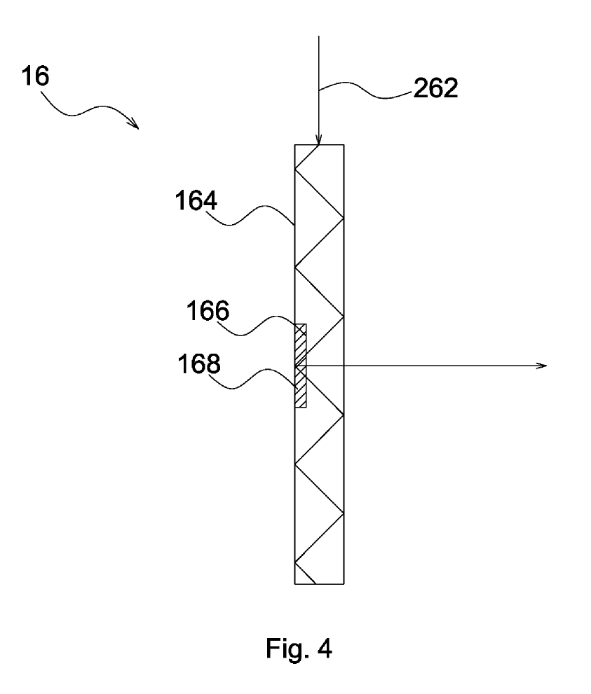

The glass body 16 includes a region in which one or more signs having one or more colors are provided. For example, this region of the glass body is constituted by at least a second pattern 162. As shown in FIG. 4, the glass body 16 has a surface 164, and the second pattern 162 is formed on the surface 164 in an embodiment. In another embodiment, the second pattern 162 is formed in the intermediate layer of the glass body. To concisely clarify the present disclosure, the following description is be based on the second pattern 162 formed on the surface 164 of the glass body 16.

In an embodiment, the surface 164 includes a groove 166 and a reflection layer 168. The groove 166 is formed by etching the surface 164, and then the reflection layer 168 is formed in the groove 166. Therefore, the second pattern 162 is formed on the surface 164. Note that the shape of the groove 166 is substantially the same as the shape of the second pattern 162. In this embodiment, the second pattern 162 includes four second branches 1624 each having graduation marks. When the glass body 16 is disposed to the mounting bracket 20, the second pattern 162 is aimed at the first pattern 122 (i.e. the second branches 1624 are respectively aimed at the first branches 1224).

Please return to FIG. 1. The base member 18 can further have a first indentation 184 formed thereon, and the mounting bracket 20 can further have a second indentation 204 formed thereon. When the mounting bracket 20 is disposed on the base member 18, the first indentation 184 and the second indentation 204 together form an accommodating space for light sources. Therefore, the first light source 24 can be disposed in the accommodating space for emitting (or projecting) a first color beam (not shown in the drawings). The first color beam emitted from the first light source 24 can be fed into the optical fiber 14 from the second end 144 of the optical fiber 14 and propagates toward the first end 142 so that the first color beam is outputted from the first end 142. On the other hand, the second light source 26 emits (or projects) a second color beam 262 as shown in FIG. 4. The second color beam 262 can pass through the through holes 206 of the mounting bracket 20 to propagate onto the glass body 16, and then is fed into the glass body 16 from a side surface of the glass body 16. As shown in FIG. 4, the second color beam 262 in the glass body 16 is continuously reflected until the second color beam 262 arrives on the reflection layer 168 and is reflected by the reflection layer 168. Therefore, the second color beam can be outputted from the second pattern 162 (i.e. the second branches 1624).

Note that the first color beam outputted from the first end 142 has higher brightness than the second color beam outputted from the second pattern 162 since the amount of decayed part of the first color beam in the optical fiber 14 is less than the amount of decayed part of the second color beam 262 in the glass body 16. In this embodiment, to eliminate the above difference in brightness, the optical structure 10 is disposed with two second light sources 26 therein and the two second light sources 26 are respectively located at two opposite sides of the glass body 16, in order to equalize the brightness of the first end 142 and the brightness of the second pattern 162.

In this or some embodiments, the color of the first color beam is substantially the same as or different from the color of the second color beam.

In this or some embodiments, the first light source 24 or the second light source 26 can be a monochromatic laser diode, a bi-color laser diode or other multi-color laser diode.

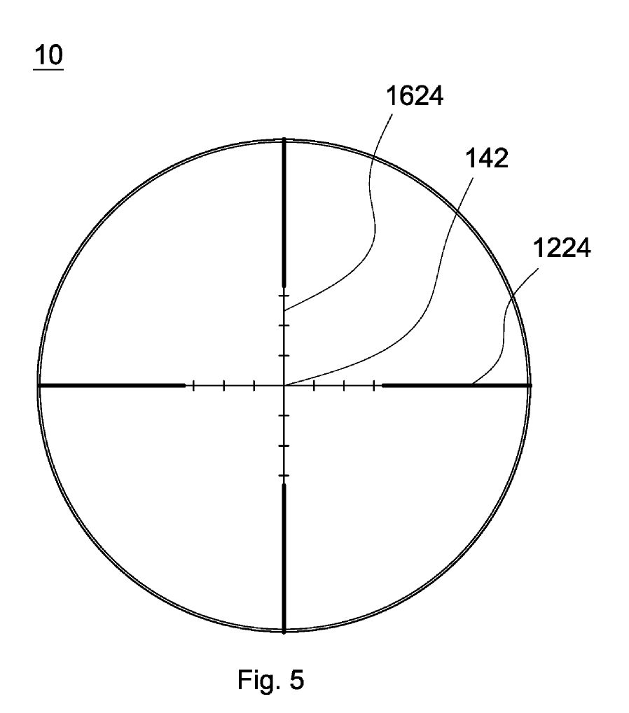

As shown in FIG. 1, a baseline B perpendicularly passes through the aiming pattern. Therefore, the user can see the aiming pattern in the FOV when gazing in the direction parallel to the baseline B through the optical structure 10. Meanwhile, the first end 142 of the optical fiber 14 (i.e. the first color beam) is located at the center of the aiming pattern, the second pattern 162 (i.e. the second color beam) surrounds the first end 142, and the first pattern 122 surrounds the second pattern 162. Therefore, the aiming pattern, as shown in FIG. 5, is formed. In this embodiment, the aiming pattern is crosshair-shaped or reticle-shaped. When the luminous reticle is observed in the direction parallel to the baseline B, it can be seen that the first color beam (i.e. the first end 142) is located at the center of the reticle, the second color beam (i.e. the four second branches 1624) surrounds the first color beam, and the first pattern 122 (i.e. a part of the four first branches 1224) surrounds the second color beam. Therefore, the reticle is formed, and the first color beam outputted from the first end 142 is visible in the second color beam outputted from the second pattern 162.

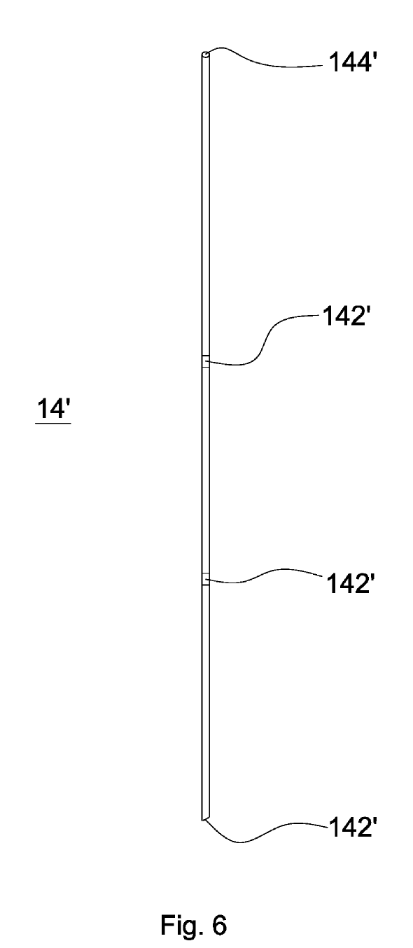

In another embodiment, the optical fiber 14′ includes a plurality of first ends 142′ and a second end 144′, as shown in FIG. 6. Similarly, the optical fiber 14′ is disposed on the first pattern 122, and the optical fiber 14′ and one of the first branches 1224 of the first pattern 122 are overlapped and assembled together. After the optical fiber 14′ and the first branch 1224 are assembled together, the first ends 142′ are sequentially positioned, from the first central point 1222, on the first branch 1224 and have the same interval or different intervals therebetween, and the second end 144′ is located at one end of the first branch 1224 far from the first central point 1222. During the use of the optical structure 10, the first color beam is fed into the optical fiber 14′ from the second end 144′ of the optical fiber 14′ and propagates to the first ends 142′ so that the first color beam is outputted from the first ends 142′. In this case, the optical fiber 14′ including a number of first ends 142′ can be a side-emitting optical fiber. Moreover, the other configuration and operations are similar to those in the foregoing embodiments, and the related description is omitted hereinafter.

In the optical structure 10 of the present disclosure, the disposition of the optical fiber 14 and the glass body 16 in the structure allows the aiming pattern in emitting light to display two colors. For example, when the first end 142 emits red light and the second pattern 162 emits green light, the user can use the red light as an aiming point and the green light as an auxiliary line of trajectory compensation in the FOV. Accordingly, the readability of different information in the FOV of the optical structure 10 may be enhanced.

Although the description of the forgoing embodiments shown in FIGS. 1 to 6 is based on a sight apparatus capable of providing a luminous aiming pattern constituted by the cross-shaped first region of the glass body and the cross-shaped second region of the main body, the present disclosure is not limited to these embodiments. One of ordinary skill in the art can freely design the shapes of the first and second regions so long as the aiming pattern can provide the aiming function and display at least two colors.

Moreover, one of ordinary skill in the art can selectively omit the second region so long as the aiming pattern constituted by the first region can provide the aiming function and display at least two colors. In the case that the second region is omitted, the optical fiber may be selectively disposed on the first region of the glass body, and the disposition of the optical fiber on the first region in this case can be referred to the disposition of the optical fiber on the second region in the previous embodiments so long as a first end of the optical fiber can be positioned at the center of the aiming pattern.

In addition, other implementations may be appreciated that the number and light colors of light sources used for the first region and/or second region can be changed according to actual application requirements.

What is claimed is:

1. An optical apparatus, comprising:
a main body;
a glass body comprising a first region;
an optical fiber located between the main body and the glass body and comprising a first end;
a first light source configured to project a first color beam, and the first color beam being fed into the optical fiber and being outputted from the first end of the optical fiber; and
a second light source configured to project a second color beam, and the second color beam being fed into the glass body and being outputted from the first region of the glass body;
wherein when the first region is observed in a direction parallel to a baseline perpendicularly passing through the first region, the first color beam outputted from the first end is visible in the second color beam outputted from the first region.

2. The optical apparatus according to claim 1, wherein the first region forms an aiming pattern, and when the aiming pattern is observed in the direction parallel to the baseline, the first end is located in a center of the aiming pattern and the first region surrounds the first end.

3. The optical apparatus according to claim 2, wherein the optical fiber is disposed on the first region of the glass body.

4. The optical apparatus according to claim 1, wherein the optical fiber further comprises a second end, and the first color beam is fed into the optical fiber from the second end and propagates toward the first end so that the first color beam is outputted form the first end.

5. The optical apparatus according to claim 1, wherein the glass body further comprises a surface, and the first region is arranged on the surface.

6. The optical apparatus according to claim 5, wherein the surface comprises a groove and a reflection layer, and the reflection layer is disposed in the groove to form the first region on the surface.

7. The optical apparatus according to claim 6, wherein the second color beam is fed into the glass body from a side surface of the glass body and is reflected by the reflection layer so that the second color beam is outputted from the first region.

8. The optical apparatus according to claim 1, wherein the optical fiber further comprises another first end, the first color beam propagating in the optical fiber is outputted from the two first ends, and the first color beam outputted from the first ends is visible in the second color beam outputted from the first region when the first region is observed in the direction parallel to the baseline.

9. The optical apparatus according to claim 8, wherein the optical fiber further comprises one more first end, the first color bream propagating in the optical fiber is outputted from the three first ends, and the three first ends have the same interval therebtween.

10. The optical apparatus according to claim 8, wherein the optical fiber further comprises one more first end, the first color bream propagating in the optical fiber is outputted from the three first ends, and the three first ends have different intervals therebtween.

11. The optical apparatus according to claim 8, wherein the optical fiber is a side-emitting optical fiber.

12. The optical apparatus according to claim 1, further comprising:
a base member configured to allow the main body to be disposed thereto.

13. The optical apparatus according to claim 12, further comprising:
a mounting bracket configured to be disposed to the base member and allow the glass body to be disposed thereto, in order to position the optical fiber between the main body and the glass body.

14. The optical apparatus according to claim 1, wherein the main body comprises a second region, the optical fiber is disposed on the second region, the first region and the second region together form an aiming pattern, and when the aiming pattern is observed in the direction parallel to the baseline, the first end is located in a center of the aiming pattern, the first region surrounds the first end and the second region surrounds the first region.

15. The optical apparatus according to claim 1, further comprising:
another second light source configured to project another second color beam, the two second light sources being located at two opposite sides of the glass body respectively, and said another second color beam being fed into the glass body and being outputted from the first region of the glass body.

16. The optical apparatus according to claim 1, further comprising an eyepiece and an object lens between which the main body, the glass body, the optical fiber and the first and second light sources are disposed.

17. An apparatus having an aiming function, comprising:
a main body;
a glass body comprising a first region;
an optical fiber located between the main body and the glass body and comprising a first end;
a first light source configured to project a first color beam, and the first color beam being fed into the optical fiber and being outputted from the first end of the optical fiber; and
a second light source configured to project a second color beam, and the second color beam being fed into the glass body and being outputted from the first region of the glass body;
wherein an aiming image for observation is provided by the first region of the glass body and the first end of the optical fiber in the optical structure.

18. The apparatus according to claim 17, further comprising an eyepiece and an object lens between which the main body, the glass body, the optical fiber and the first and second light sources are disposed.
